(19) United States
(12) Patent Application Publication
(10) Pub. No.: US 2015/0187348 A1
(43) Pub. Date: Jul. 2, 2015

(54) APPARATUS AND METHOD FOR CANCELLING ACOUSTIC ECHO

(71) Applicant: Electronics and Telecommunications Research Institute, Daejeon (KR)

(72) Inventors: Hun Sik KANG, Daejeon (KR); Do Young KIM, Daejeon (KR)

(21) Appl. No.: 14/578,209

(22) Filed: Dec. 19, 2014

(30) Foreign Application Priority Data
Dec. 31, 2013 (KR) 10-2013-0169313

(51) Int. Cl. G10K 11/175

(52) U.S. Cl. CPC G10K 11/175

(57) ABSTRACT

An apparatus for cancelling an acoustic echo estimates power of a non-linear distortion component of a line amplifier from a signal generated by passing a far-end signal through the line amplifier, controls a gain of the line amplifier using a power estimate of the non-linear distortion component, generates an acoustic echo estimation signal from the far-end signal, and subtracts the acoustic echo estimation signal from a signal input through a microphone to cancel an acoustic echo signal.

### CROSS-REFERENCE TO RELATED APPLICATION

This application claims priority to and the benefit of Korean Patent Application No. 10-2013-0169313 filed in the Korean Intellectual Property Office on Dec. 31, 2013, the entire contents of which are incorporated herein by reference.

### BACKGROUND OF THE INVENTION

(a) Field of the Invention

The present invention relates to an apparatus and a method for cancelling an acoustic echo. More particularly, the present invention relates to an apparatus and a method for cancelling an acoustic echo capable of cancelling the acoustic echo using an adaptive filter.

(b) Description of the Related Art

An acoustic echo occurs when a speech signal from an opposite party (far-end) that is output from a speaker of a terminal apparatus is input to a microphone through various acoustic channel paths to thereby be transferred to the other party. The acoustic echo hinders normal communication between call parties.

In a telepresence system or a video conference system for smartwork, since a conference is conducted based on a speaker, it is very important to cancel the acoustic echo.

An acoustic echo canceller for cancelling the acoustic echo uses a method of estimating an acoustic echo channel using an adaptive filter.

The acoustic echo canceller using the adaptive filter performs convolution on a reference signal, that is, a far-end signal, using an adaptive filter coefficient. That is, the adaptive filter, which performs a linear operation on an input signal, cancels the acoustic echo on the assumption that a model of an acoustic echo channel has linear characteristics. However, in an actual system, the acoustic echo channel between the speaker and the microphone does not have the linear characteristics. Non-linear characteristics are also generated in the acoustic echo channel between the speaker and the microphone. Particularly, the non-linear characteristics are also generated in an audio codec chip. The audio codec chip includes a microphone amplifier amplifying an input signal of the microphone, an analog-to-digital converter (ADC) converting the signal amplified by the microphone amplifier from an analog signal into a digital signal, a digital-to-analog converter (DAC) converting a far-end signal from a digital signal into an analog signal, a line amplifier amplifying the analog signal output from the DAC and outputting the amplified signal to a speaker, and the like. Since the line amplifier among these components in the audio codec chip has a form of a power amplifier, in the case in which the far-end signal is large or an amplification degree is high, the line amplifier shows the non-linear characteristics. In the case in which the far-end signal passes through the line amplifier having these non-linear characteristics and then passes through the acoustic echo channel, an existing acoustic echo canceller in a linear scheme may not cancel acoustic echo components in which non-linear distortion is generated, such that deterioration of sound quality occurs for the opposite party of a call.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for cancelling an acoustic echo that is capable of preventing deterioration of acoustic echo cancelling performance due to non-linear distortion.

An exemplary embodiment of the present invention provides a method for cancelling an acoustic echo by an apparatus for cancelling an acoustic echo. The method includes: receiving a far-end signal; generating an acoustic echo estimation signal from the far-end signal; estimating power of a non-linear distortion component of a line amplifier from a line amplifier signal generated by passing the far-end signal through the line amplifier; controlling a gain of the line amplifier using a power estimate of the non-linear distortion component; and subtracting the acoustic echo estimation signal from a microphone input signal generated by passing a near-end signal through a microphone.

The estimating may include: converting the far-end signal and the line amplifier signal into a plurality of first frequency domain signals and a plurality of second frequency domain signals, respectively, by performing fast Fourier transform (FFT) on the far-end signal and the line amplifier signal; calculating average power of the plurality of first frequency domain signals and average power of the plurality of second frequency domain signals; and calculating the power estimate of the non-linear distortion component using the average power of the plurality of first frequency domain signals and the average power of the plurality of second frequency domain signals.

The calculating may include calculating the power estimate of the non-linear distortion component from a difference between the average power of the plurality of first frequency domain signals and the average power of the plurality of second frequency domain signals.

The calculating may further include: calculating noise power from the plurality of second frequency domain signals; and compensating for the noise power in the average power of the plurality of first frequency domain signals.

The estimating may further include, before the converting, coinciding start points in time of the far-end signal and the line amplifier signal to coincide with each other.

The coinciding of the start points in time of the far-end signal and the line amplifier signal to coincide with each other may include: estimating a delay value corresponding to a difference between a reception time of the far-end signal and a reception time of the line amplifier signal; and delaying the far-end signal by the delay value.

The estimating of the delay value may include: determining a point at which average power of the far-end signal exceeds a predetermined threshold value to be the start point in time of the far-end signal; determining a point at which average power of the line amplifier signal exceeds the threshold value to be the start point in time of the line amplifier signal; and estimating the delay value from a difference between the start point in time of the far-end signal and the start point in time of the line amplifier signal.

The calculating may include: calculating a correlation of frequency spectrums between the plurality of first frequency domain signals and the plurality of second frequency domain signals; and calculating the power estimate of the non-linear distortion component when the correlation of the frequency spectrums exceeds a predetermined threshold value.

The controlling may include determining a square root value of the power estimate of the non-linear distortion component to be the gain of the line amplifier.

The generating may include: estimating an impulse response of an acoustic echo channel using a step magnitude; and generating the acoustic echo estimation signal by filtering the far-end signal using the impulse response as a filter coefficient.

The subtracting may include subtracting the acoustic echo estimation signal from the microphone input signal to generate an error signal, and the generating of the acoustic echo estimation signal may further include determining the step magnitude using the far-end signal and the error signal.

Another embodiment of the present invention provides an apparatus for cancelling an acoustic echo in a system in which a far-end signal input through a network is output through a line amplifier and a speaker, and a near-end signal input through a microphone is output through the network. The apparatus for cancelling an acoustic echo includes an adaptive filter, a non-linear distortion controller, and an error signal generator. The adaptive filter generates an acoustic echo estimation signal from the far-end signal input through the network. The non-linear distortion controller estimates power of a non-linear distortion component of the line amplifier from a line amplifier signal generated by passing the far-end signal through the line amplifier, and controls a gain of the line amplifier using a power estimate of the non-linear distortion component. The error signal generator obtains an error signal to be output through the network by subtracting the acoustic echo estimation signal from a microphone input signal.

The non-linear distortion controller may include: first and second FFT units converting the far-end signal and the line amplifier signal into a plurality of first frequency domain signals and a plurality of second frequency domain signals, respectively, by performing FFT on the far-end signal and the line amplifier signal; and a non-linear distortion power estimator calculating the power estimate of the non-linear distortion component using average power of the plurality of first frequency domain signals and average power of the plurality of second frequency domain signals.

The non-linear distortion controller may further include a gain controller controlling the gain of the line amplifier by a square root value of the power estimate of the non-linear distortion component.

The non-linear distortion controller may further include: a delay detector estimating a delay value corresponding to a difference between an input point in time of the far-end signal and an input time of the line amplifier signal; and a delay filter delaying the far-end signal by the delay value and then outputting the far-end signal to the first FFT unit.

The non-linear distortion power estimator may calculate the power estimate of the non-linear distortion component from a difference between the average power of the plurality of first frequency domain signals and the average power of the plurality of second frequency domain signals.

The non-linear distortion controller may further include a noise estimator estimating noise power from the plurality of second frequency domain signals, and the non-linear distortion power estimator may compensate for the noise power in the average power of the plurality of first frequency domain signals.

The non-linear distortion controller may further include a frequency correlation estimator calculating a correlation of frequency spectrums between the plurality of first frequency domain signals and the plurality of second frequency domain signals, and the non-linear distortion power estimator may calculate the power estimate of the non-linear distortion component when the correlation of the frequency spectrums exceeds a predetermined threshold value.

The apparatus may further include a step magnitude estimator estimating a step magnitude using the far-end signal and the error signal, wherein the adaptive filter estimates an impulse response of an acoustic echo channel, generates the acoustic echo estimation signal by filtering the far-end signal using the impulse response as a filter coefficient, and controlling an adaptation speed of the adaptive filter using the step magnitude.

### BRIEF DESCRIPTION OF THE DRAWINGS

FIG. 1 is a drawing showing an apparatus for cancelling an acoustic echo according to an exemplary embodiment of the present invention.

FIG. 2 is a drawing showing a non-linear distortion controller shown in FIG. 1.

FIG. 3 is a flowchart showing a method for controlling a gain of a line amplifier by the non-linear distortion controller shown in FIG. 2.

FIG. 4 is a flowchart of a method for cancelling an acoustic echo according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Hereinafter, an apparatus and a method for cancelling an acoustic echo according to an exemplary embodiment of the present invention will be described in detail with reference to the accompanying drawings.

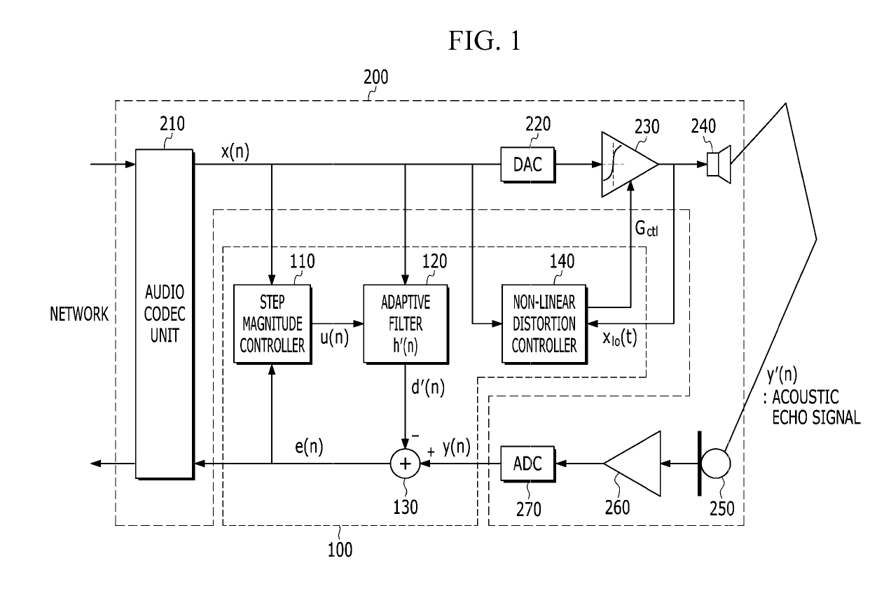

FIG. 1 is a drawing showing an apparatus for cancelling an acoustic echo according to an exemplary embodiment of the present invention.

Referring to FIG. 1, the apparatus 100 for cancelling an acoustic echo is used in order to cancel an acoustic echo inevitably generated in a system 200 such as a long distance conference system, a telepresence system, a hands-free call system in a vehicle, or the like.

Generally, the system 200 is configured to include an audio codec unit 210, a digital-to-analog converter (DAC) 220, a line amplifier 230, a speaker 240, a microphone 250, a microphone amplifier 260, an analog-to-digital converter (ADC) 270. Here, the DAC 220, the line amplifier 230, the microphone amplifier 260, and the ADC 270 may be implemented by a single chip.

A far-end signal [x(n)] received from a remote apparatus through a network is compression-converted from an analog signal into a digital signal by the audio codec unit 210, and the compression-converted digital signal is converted into an analog signal by the DAC 220. The analog signal is amplified by the line amplifier 230 and is output through the speaker 240.

In addition, a near-end signal is input through the microphone 250, and a microphone input signal input through the microphone 250 is amplified by the microphone amplifier 260 and is then converted from an analog signal into a digital signal by the ADC 270. The digital signal is compression-converted into an analog signal by the audio codec unit 210 and is output through the network.

In the system 200 as described above, a phenomenon that the far-end signal [x(n)] output through the speaker 240 passes through an acoustic echo channel between the speaker 240 and the microphone 250 and is then input to the microphone 250, that is, an acoustic echo, occurs. That is, a signal corresponding to the sum of the near-end signal and the acoustic echo signal is output as a microphone input signal to hinder normal communication between call parties. Therefore, the system 200 includes the apparatus 100 for cancelling an acoustic echo for cancelling the acoustic echo signal.

The apparatus 100 for cancelling an acoustic echo is configured to include a step magnitude controller 110, an adaptive filter 120, an error signal generator 130, and a non-linear distortion controller 140.

The step magnitude controller 110 determines a step magnitude [u(n)] using the far-end signal, that is, a reference signal [x(n)], input through the network and an error signal [e(n)].

The adaptive filter 120 estimates a channel impulse response [h′(n)] of the acoustic echo channel using the reference signal [x(n)] and the error signal [e(n)], and filters the reference signal [x(n)] using the channel impulse response [h′(n)] using a filter coefficient to generate an acoustic echo estimation signal [d′(n)]. In addition, the adaptive filter 120 may control an adaptation speed of the adaptive filter 120 and accuracy of an estimation impulse response thereof using the step magnitude [u(n)].

The error signal generator 130 generates the error signal [e(n)] by subtracting the acoustic echo estimation signal [d′(n)] from a microphone input signal [y(n)] input through the microphone 250. The error signal [e(n)] is a signal from which the acoustic echo signal is cancelled. That is, the microphone input signal [y(n)] is a signal generated by combining the acoustic echo signal [y′(n)] input through the acoustic echo channel and near-end signal with each other. Therefore, when the acoustic echo estimation signal [d′(n)] is subtracted from the microphone input signal [y(n)], the acoustic echo signal is cancelled, such that only the near-end signal remains.

The error signal [e(n)] is input to the step magnitude controller 110 estimating the step magnitude [u(n)] of the adaptive filter 120, and is used to estimate the impulse response of the acoustic echo channel.

When this feedback operation is repeated several times, the error signal [e(n)] becomes gradually smaller, such that the acoustic echo signal [y′(n)] may be completely cancelled.

Meanwhile, the adaptive filter 120 cancels the acoustic echo signal [y′(n)] through a linear operation on the assumption of a linear acoustic echo channel. However, the line amplifier 230 has non-linear characteristics as represented by Equation 1.

$$G ( x ( n ) ) = {g}_{1} x ( n ) + {g}_{2} {x ( n )}^{2} + {g}_{3} {x ( n )}^{i} + … = {\sum }_{i = 0}^{∞} {g}_{i} {x ( n )}^{i} \qquad ( Equation 1 )$$

Non-linear distortion of the reference signal [x(n)] is generated by the line amplifier 230 having these non-linear characteristics, and the adaptive filter 120 in the apparatus 100 for cancelling an acoustic echo may not cancel the non-linearly distorted acoustic echo components when the non-linearly distorted signal passes through the acoustic echo channel and is then introduced into the microphone 250.

Here, the non-linear distortion generated by the line amplifier 230 is mixed with a frequency such as a double frequency, a triple frequency, or the like, of a component of an input frequency in a frequency domain to distort an input frequency spectrum. Therefore, when power of a frequency distortion component is estimated, a gain of the line amplifier 230 is controlled using the power of the frequency distortion component, thereby making it possible to allow the line amplifier 230 to not be operated in a non-linear region.

The non-linear distortion controller 140 estimates the power of the frequency distortion component of the line amplifier 230 to control the gain of the line amplifier 230 so that the line amplifier 230 does not generate the non-linear distortion.

In this case, the acoustic echo signal [y′(n)] introduced into the microphone 250 may have linear characteristics, such that the acoustic echo signal [y′(n)] may be completely cancelled by the apparatus 100 for cancelling an acoustic echo.

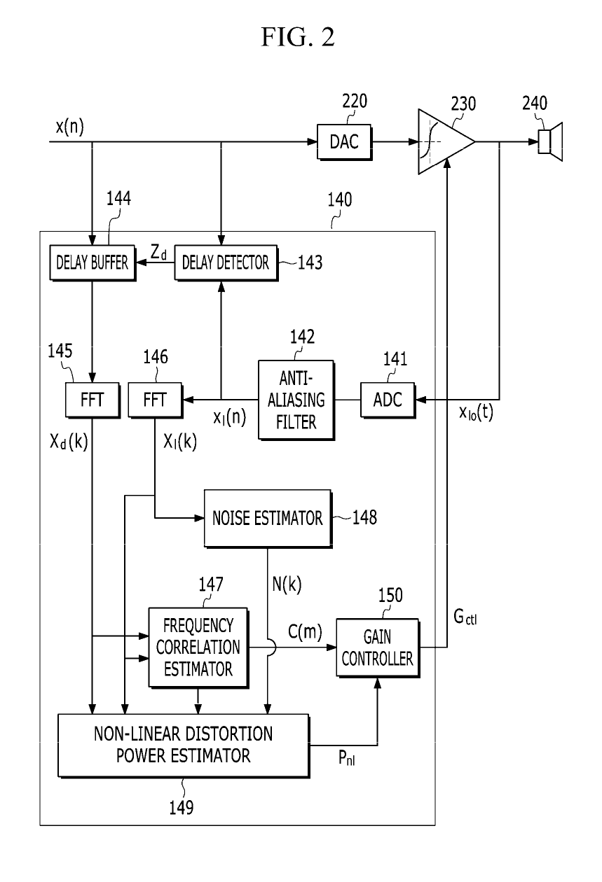

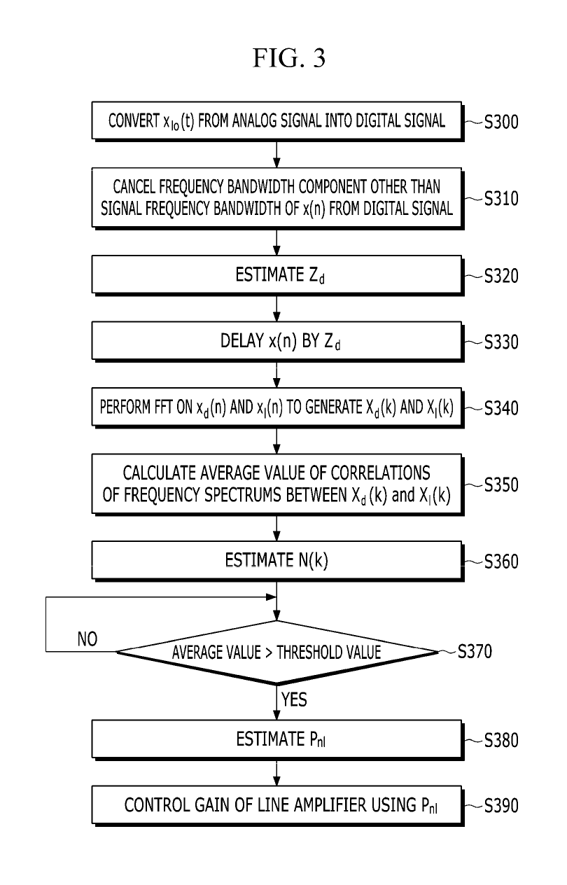

FIG. 2 is a drawing showing a non-linear distortion controller shown in FIG. 1, and FIG. 3 is a flowchart showing a method for controlling a gain of a line amplifier by the non-linear distortion controller shown in FIG. 2.

Referring to FIG. 2, the non-linear distortion controller 140 is configured to include an ADC 141, an anti-aliasing filter 142, a delay detector 143, a delay buffer 144, fast Fourier transform (FFT) units 145 and 146, a frequency correlation estimator 147, a noise estimator 148, a non-linear distortion power estimator 149, and a gain controller 150.

Referring to FIG. 3, the ADC 141 converts an output signal [xₗₒ(t)] of the line amplifier 230 from an analog signal into a digital signal in order to sense the non-linear distortion of the line amplifier 230 (S300).

The anti-aliasing filter 142 cancels a frequency bandwidth component other than a signal frequency bandwidth of the reference signal [x(n)] from an output signal of the ADC 141 (S310).

A delay occurs in the signal l[xₗ(n)] passing through the anti-aliasing filter 142 by components such as the DAC 220, the line amplifier 230, and the like. The delay detector 143 estimates a delay value Z_{d} using the reference signal [x(n)] and the signal [xₗ(n)] (S320). That is, the delay detector 143 may estimate the delay value Z_{d} from a time difference between an input point in time of the reference signal [x(n)] and an input point in time of the signal [xₗ(n)].

The delay detector 143 averages each of the powers of two input signals [x(n), xₗ(n)] to set points at which the averaged powers exceed a threshold power value to start points in time of the respective input signals [x(n), xₗ(n)], and calculates a difference between the start points in time of two input signals [x(n), xₗ(n)] to estimate the delay value Z_{d} from the difference between the start points in time of two input signals [x(n), xₗ(n)]. The difference between the start points in time of two input signals [x(n), xₗ(n)] may be calculated as represented by Equation 2.

$${Z}_{d} = {Z}_{x} - {Z}_{x l} \\ {Z}_{x} = sample number of ( \frac{1}{L} {\sum }_{i = 0}^{L - 1} {\vert x ( n ) \vert}^{2} \geq {P}_{th} ) \\ {Z}_{x l} = sample number of ( \frac{1}{L} {\sum }_{i = 0}^{L - 1} {\vert {x}_{l} ( n ) \vert}^{2} \geq {P}_{th} ) \qquad ( Equation 2 )$$

In Equation 2, Pₜₕ indicates a threshold power value for knowing a start of a signal, Zₓ indicates a signal start point in time of x(n), Zₓₗ indicates a signal start point in time of xₗ(n), and L indicates the number of samples for calculating an average power. The delay buffer 144 delays the reference signal [x(n)] by the delay value (Z_{d}) and then outputs the reference signal [x(n)] (S330). The reason why the reference signal [x(n)] is delayed by the delay buffer 144 is to coincide start points in time of the reference signal [x(n)] and the signal [xₗₒ(t)] passing through the line amplifier 230 to coincide with each other, thereby allowing signal sections required for estimating power of the non-linear frequency distortion component to be the same as each other.

The FFT units 145 and 146 perform FFT on a delay signal [x_{d}(n)] generated by delaying the reference signal [x(n)] and the signal [xₗ(n)] passing through the anti-aliasing filter 142 to generate frequency domain signals [X_{d}(k), Xₗ(k)] (S340), in order to estimate powers of frequency distortion components, respectively. That is, the delay signal [x_{d}(n)] and the signal [xₗ(n)] are converted into the signals [X_{d}(k), Xₗ(k)] having N frequency components in an in-band signal region while passing through the FFT units 145 and 146, respectively.

In order to estimate non-linear distortion of a frequency of Xₗ(k) to a frequency spectrum X_{d}(k) of the reference signal [x(n)], similarity of frequency spectrums between two signals [X_{d}(k), Xₗ(k)] should be detected, which is performed by the frequency correlation estimator 147.

The frequency correlation estimator 147 calculates an average value of correlations of the frequency spectrums between the frequency domain signals [X_{d}(k), Xₗ(k)] and calculates an average value of the correlations of the frequency spectrums (S350). The correlations of the frequency spectrums between the frequency domain signals [X_{d}(k), Xₗ(k)] may be calculated as represented by Equation 3.

$$C ( m = N ) = \frac{1}{{N}_{c}} {\sum }_{l = 0}^{{N}_{c} - 1} {\sum }_{k = 0}^{N - 1} \vert {X}_{d} ( Nl + k ) \vert \cdot \vert {X}_{l} ( Nl + k + m ) \vert \qquad ( Equation 3 )$$

In Equation 3, C(m) indicates a correlation of frequency spectrums between two signals [Xd(k), Xl(k)] having a difference of m samples, N indicates the number of FFTs, and N_{c} indicates the number of blocks for calculating an average value for accuracy of correlation estimation.

The noise estimator 148 estimates noise power N(k) from the frequency domain signal [Xₗ(k)] (S360).

The non-linear distortion power estimator 149 compares the average value of the correlations of the frequency spectrums with a predetermined threshold value (S370), and estimates that distortion has been generated in the frequency spectrums in the case in which the average value of the correlations of the frequency spectrums exceeds the threshold value. The non-linear distortion power estimator 149 estimates power Pₙₗ of a frequency distortion component (S380) when the average value of the correlations of the frequency spectrums exceeds the threshold value. The non-linear distortion power estimator 149 may estimate the power of the non-linear distortion component by calculating average power of the frequency domain signals [X_{d}(k), Xₗ(k)]. Here, the signal [Xₗ(k)] includes a noise signal while passing through the DAC 220, the line amplifier 230, or the like. Therefore, the non-linear distortion power estimator 149 compensates the power of the frequency domain signal [X_{d}(k)] using the noise power [N(k)], and then estimates the power of the frequency distortion component through a difference between the power of the frequency domain signal [Xd(k)] from which the noise power is compensated for and power of the frequency domain signal [Xₗ(k)]. In addition, since the output signal [xₗₒ(t)] of the line amplifier 230 is generated by amplifying the reference signal [x(n)], it should also be considered at the time of estimating non-linear distortion power. The power estimate Pₙₗ of the non-linear distortion component estimated in consideration of the above-mentioned two contents may be represented by Equation 4.

$${P}_{nl} = {\sum }_{k = 0}^{N - 1} ( {\vert {X}_{d} ( k ) \vert}^{2} \cdot {G}_{la}^{2} + {\vert N ( k ) \vert}^{2} - {\vert {X}_{l} ( k ) \vert}^{2} ) \qquad ( Equation 4 )$$

The gain controller 150 control a gain of the line amplifier 230 using the power estimate Pₙₗ of the non-linear distortion component (S390). The gain of the line amplifier 230 may be determined to be a square root value of the power estimate Pₙₗ of the non-linear distortion component.

As described above, the non-linear distortion controller 140 controls the gain so that the line amplifier 230 does not generate the non-linear distortion, thereby allowing the acoustic echo component introduced into the microphone to have linear characteristics.

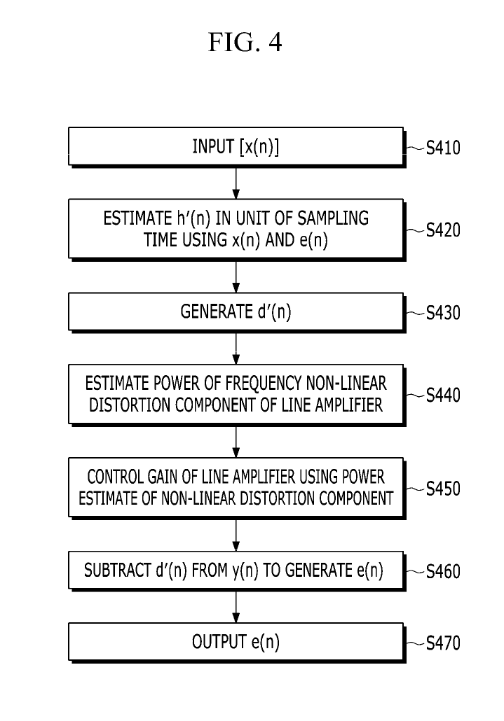

FIG. 4 is a flowchart of a method for cancelling an acoustic echo according to an exemplary embodiment of the present invention.

Referring to FIG. 4, when the far-end signal [x(n)] is input (S410), the adaptive filter 220 estimates the impulse response [h′(n)] of the acoustic echo channel in a unit of the step magnitude [u(n)] using the far-end signal [x(n)] and the error signal [e(n)] (S420). The adaptive filter 220 generates the acoustic echo estimation signal [d′(n)] from the far-end signal [x(n)] using the estimated impulse response [h′(n)] as the filter coefficient (S430).

Next, the non-linear distortion controller 140 estimates the power of the frequency non-linear distortion component of the line amplifier 230 (S440) and controls the gain of the line amplifier 230 using the power estimate Pₙₗ of the non-linear distortion component (S450), as described above with reference to FIG. 3.

Then, the error signal generator 130 subtracts the acoustic echo estimation signal [d′(n)] from the microphone output signal [y(n)] to generate the error signal [e(n)] (S460), and outputs the error signal [e(n)] through the network (S470). Here, the error signal [e(n)] is input to the step magnitude controlling 110 estimating the step magnitude [u(n)] of the adaptive filter 120.

When this feedback operation is repeated several times, the error signal becomes gradually smaller, such that the acoustic echo signal [y′(n)] may be cancelled. According to an exemplary embodiment of the present invention, the gain of the line amplifier is controlled so that the non-linear distortion is not generated in the line amplifier, thereby making it possible to allow the acoustic echo component introduced into the microphone to have linear characteristics. Therefore, the apparatus for cancelling an acoustic echo using the adaptive filter may completely cancel the acoustic echo. The above-mentioned exemplary embodiments of the present invention are not embodied only by an apparatus and method. Alternatively, the above-mentioned exemplary embodiments may be embodied by a program performing functions which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for cancelling an acoustic echo by an apparatus for cancelling an acoustic echo, comprising:
receiving a far-end signal;
generating an acoustic echo estimation signal from the far-end signal;
estimating power of a non-linear distortion component of a line amplifier from a line amplifier signal generated by passing the far-end signal through the line amplifier;
controlling a gain of the line amplifier using a power estimate of the non-linear distortion component; and
subtracting the acoustic echo estimation signal from a microphone input signal generated by passing a near-end signal through a microphone.

2. The method of claim 1, wherein
the estimating includes:
converting the far-end signal and the line amplifier signal into a plurality of first frequency domain signals and a plurality of second frequency domain signals, respectively, by performing fast Fourier transform (FFT) on the far-end signal and the line amplifier signal;
calculating average power of the plurality of first frequency domain signals and average power of the plurality of second frequency domain signals; and
calculating the power estimate of the non-linear distortion component using the average power of the plurality of first frequency domain signals and the average power of the plurality of second frequency domain signals.

3. The method of claim 2, wherein
the calculating includes calculating the power estimate of the non-linear distortion component from a difference between the average power of the plurality of first frequency domain signals and the average power of the plurality of second frequency domain signals.

4. The method of claim 3, wherein
the calculating further includes:
calculating noise power from the plurality of second frequency domain signals; and
compensating for the noise power in the average power of the plurality of first frequency domain signals.

5. The method of claim 2, wherein
the estimating further includes, before the converting, coinciding start points in time of the far-end signal and the line amplifier signal to coincide with each other.

6. The method of claim 5, wherein
the coinciding of the start points in time of the far-end signal and the line amplifier signal to coincide with each other includes:
estimating a delay value corresponding to a difference between a reception time of the far-end signal and a reception time of the line amplifier signal; and
delaying the far-end signal by the delay value.

7. The method of claim 6, wherein
the estimating of the delay value includes:
determining a point at which average power of the far-end signal exceeds a predetermined threshold value to be the start point in time of the far-end signal;
determining a point at which average power of the line amplifier signal exceeds the threshold value to be the start point in time of the line amplifier signal; and
estimating the delay value from a difference between the start point in time of the far-end signal and the start point in time of the line amplifier signal.

8. The method of claim 2, wherein
the calculating includes:
calculating a correlation of frequency spectrums between the plurality of first frequency domain signals and the plurality of second frequency domain signals; and
calculating the power estimate of the non-linear distortion component when the correlation of the frequency spectrums exceeds a predetermined threshold value.

9. The method of claim 1, wherein
the controlling includes determining a square root value of the power estimate of the non-linear distortion component to be the gain of the line amplifier.

10. The method of claim 1, wherein
the generating includes:
estimating an impulse response of an acoustic echo channel using a step magnitude; and
generating the acoustic echo estimation signal by filtering the far-end signal using the impulse response as a filter coefficient.

11. The method of claim 10, wherein
the subtracting includes subtracting the acoustic echo estimation signal from the microphone input signal to generate an error signal, and
the generating of the acoustic echo estimation signal further includes determining the step magnitude using the far-end signal and the error signal.

12. An apparatus for cancelling an acoustic echo in a system in which a far-end signal input through a network is output through a line amplifier and a speaker, and a near-end signal input through a microphone is output through the network, comprising:
an adaptive filter generating an acoustic echo estimation signal from the far-end signal input through the network;
a non-linear distortion controller estimating power of a non-linear distortion component of the line amplifier from a line amplifier signal generated by passing the far-end signal through the line amplifier and controlling a gain of the line amplifier using a power estimate of the non-linear distortion component; and
an error signal generator obtaining an error signal to be output through the network by subtracting the acoustic echo estimation signal from a microphone input signal.

13. The apparatus of claim 12, wherein
the non-linear distortion controller includes:
first and second fast Fourier transform (FFT) units converting the far-end signal and the line amplifier signal into a plurality of first frequency domain signals and a plurality of second frequency domain signals, respectively, by performing FFT on the far-end signal and the line amplifier signal; and
a non-linear distortion power estimator calculating the power estimate of the non-linear distortion component using average power of the plurality of first frequency domain signals and average power of the plurality of second frequency domain signals.

14. The apparatus of claim 13, wherein
the non-linear distortion controller further includes a gain controller controlling the gain of the line amplifier by a square root value of the power estimate of the non-linear distortion component.

15. The apparatus of claim 13, wherein
the non-linear distortion controller further includes:
a delay detector estimating a delay value corresponding to a difference between an input time in time of the far-end signal and an input time of the line amplifier signal; and
a delay filter delaying the far-end signal by the delay value and then outputting the far-end signal to the first FFT unit.

16. The apparatus of claim 13, wherein
the non-linear distortion power estimator calculates the power estimate of the non-linear distortion component from a difference between the average power of the plurality of first frequency domain signals and the average power of the plurality of second frequency domain signals.

17. The apparatus of claim 16, wherein
the non-linear distortion controller further includes a noise estimator estimating noise power from the plurality of second frequency domain signals, and
the non-linear distortion power estimator compensates the average power of the plurality of first frequency domain signals using the noise power.

18. The apparatus of claim 13, wherein
the non-linear distortion controller further includes a frequency correlation estimator calculating a correlation of frequency spectrums between the plurality of first frequency domain signals and the plurality of second frequency domain signals, and
the non-linear distortion power estimator calculates the power estimate of the non-linear distortion component when the correlation of the frequency spectrums exceeds a predetermined threshold value.

19. The apparatus of claim 12, further comprising
a step magnitude estimator estimating a step magnitude using the far-end signal and the error signal,
wherein the adaptive filter estimates an impulse response of an acoustic echo channel, generates the acoustic echo estimation signal by filtering the far-end signal using the impulse response as a filter coefficient, and controlling an adaptation speed of the adaptive filter using the step magnitude.
